(19) United States
(12) Patent Application Publication
(10) Pub. No.: US 2010/0064129 A1
(43) Pub. Date: Mar. 11, 2010

(54) Network adapter and communication device

(75) Inventors: Ryoki Honjo, Kanagawa (JP); Shinobu Kuriya, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/584,228

(22) Filed: Sep. 2, 2009

(30) Foreign Application Priority Data
Sep. 9, 2008 (JP) P2008-231546

(51) Int. Cl. H04L 9/00

(52) U.S. Cl. 713/150

(57) ABSTRACT

A network adapter includes: a network connection unit which is connected to a network, transmitting and receiving packet data; a bus connection unit which is connected to a bus, transmitting and receiving data and control information to a host device; an encryption/decryption processing unit executing an encryption/decryption application which encrypts contents or decrypts the encrypted contents; and a control unit executing software including respective hierarchies of a socket interface, a protocol stack and a device driver, and wherein the encryption/decryption application performs communication with the network connection unit or the bus connection unit through the socket interface, and wherein the control unit controls transmission and reception of data and control information of the bus connection unit by using a network device driver as the device driver.

### CROSS-REFERENCE TO RELATED APPLICATION

The present application claims priority from Japanese Patent Application No. JP 2008-231546 filed in the Japanese Patent Office on Sep. 9, 2008, the entire content of which is incorporated herein by reference.

### BACKGROUND OF THE INVENTION

1. Field of the Invention

The invention relates to a network adapter and a communication device capable of being connected to a host device by a general-purpose bus such as a PCI (Peripheral Component Interconnect).

2. Description of the Related Art

In recent years, attributes such as “10 copies permitted” and “copy not-permitted (viewing permitted)” are given to digital contents for protecting copyrights. It is possible to deliver digital contents by connecting a recording device complying with a standard such as a DNLA (Digital Living Network Alliance) to a home network (LAN: Local Area Network) at home.

When digital contents in which copyrights are protected are transferred in the above network, Digital Rights Management (DRM) such as authentication between devices and encryption of contents will be necessary. It is proposed that a DRM function is provided in a Network Front End (NFE) connected to the host device because the DRM function causes relatively high processing load (For example, JP2006-148451 (Patent Document 1).

### SUMMARY OF THE INVENTION

In the case that the NFE is responsible for the DRM function as described above, dedicated drivers for performing communication between the NFE and the host device by using the general-purpose bus such as the PCI (Peripheral Component Interconnect) are normally mounted on both devices. In this case, the dedicated driver and a DRM application at the NFE side and the dedicated driver and a DRM application at the host device side have unique APIs (Application Program Interfaces) respectively.

Accordingly, it is necessary that the host device, when connecting to a network, makes an access not only by using a network function of the NFE but also by using a general-purpose network function.

The host device may be provided with a general-purpose network interface independently, however, it is difficult to ignore physical costs and load costs of a host CPU (Central Processing Unit) necessary for network processing.

It can be also considered that a driver for the general-purpose network is mounted on the host device in addition to the dedicated driver of the DRM function, however, it is necessary to solve problems such that both drivers have to be developed at the same time and that competition is generated because the both drivers share one PCI device.

Thus, it is desirable to provide a network adapter and a communication device which exert the general-purpose network function as well as the DRM function to reduce the load of the host device.

According to an embodiment of the invention, there is provided a network adapter including a network connection unit which is connected to a network, transmitting and receiving packet data, a bus connection unit which is connected to a bus, transmitting and receiving data and control information to a host device, an encryption/decryption processing unit executing an encryption/decryption application which encrypts contents or decrypts the encrypted contents and a control unit executing software including respective hierarchies of a socket interface, a protocol stack and a device driver, in which the encryption/decryption application performs communication with the network connection unit or the bus connection unit through the socket interface, and in which the control unit controls transmission and reception of data and control information of the bus connection unit by using a network device driver as the device driver.

Also according to another embodiment of the invention, there is provided a communication device including a network adapter including a network connection unit which is connected to a network, transmitting and receiving packet data, a bus connection unit which is connected to a bus, transmitting and receiving data and control information to a host device, an encryption/decryption processing unit executing an encryption/decryption application which encrypts contents or decrypts the encrypted contents and a network control unit executing software including respective hierarchies of a socket interface, a protocol stack and a device driver, and a host device including a device connection unit connected to the network adapter through the bus and a host control unit executing software including respective hierarchies of the socket interface, the protocol stack and the device driver, in which the encryption/decryption application performs communication with the network connection unit or the bus connection unit through the socket interface, and in which the network control unit and the host control unit control transmission and reception of data and control information between the bus connection unit and the device connection unit by using a network device driver as the device driver.

According to the embodiments of the invention, the network device drivers are mounted on both sides of the network adapter and the host device as device drivers, and bus communication between the network adapter and the host device is controlled, thereby realizing both communication with respect to the DRM application and general-purpose network access, which can reduce the load of the host device.

### BRIEF DESCRIPTION OF THE DRAWINGS

FIG. 1 is a diagram showing a configuration example of the whole network;

FIG. 2A is a diagram showing a communication method of Ethernet;

FIG. 2B is a diagram showing a communication method of Ethernet;

FIG. 3 is a block diagram showing a configuration example of a bus communication between an NFE and a host device;

FIG. 4 is a view showing a description example of a DMA descriptor;

FIG. 5A is a view showing initialization processing of DMA transfer;

FIG. 5B is a view showing initialization processing of DMA transfer;

FIG. 6 is a view showing a description example of DMA descriptor definition;

FIG. 7A to FIG. 7C are views showing description examples of Tx/Rx buffer descriptor definition;

FIG. 8 is a view showing an example of specific data of an IOP;

FIG. 9 is a view showing an example of specific data of an NFE;

FIG. 10A is a diagram showing processing of simple DMA transfer;

FIG. 10B is a diagram showing processing of simple DMA transfer;

FIG. 11A and FIG. 11B are views showing part of specific data of the IOP and the NFE;

FIG. 12 is a diagram for explaining creating processing of a TxBD for a header;

FIG. 13 is a diagram for explaining creating processing of a TxBD;

FIG. 14A to FIG. 14C are views showing description examples of Tx/Rx buffer descriptor definition;

FIG. 15 is a diagram for explaining creating processing of a TxBD for a header;

FIG. 16 is a diagram for explaining creating processing of TxBDs; and

FIG. 17 is a diagram for explaining receiving processing of the NFE.

### DESCRIPTION OF THE PREFERRED EMBODIMENTS

Hereinafter, a specific embodiment of the invention will be explained in detail with reference to the drawings in the following order.

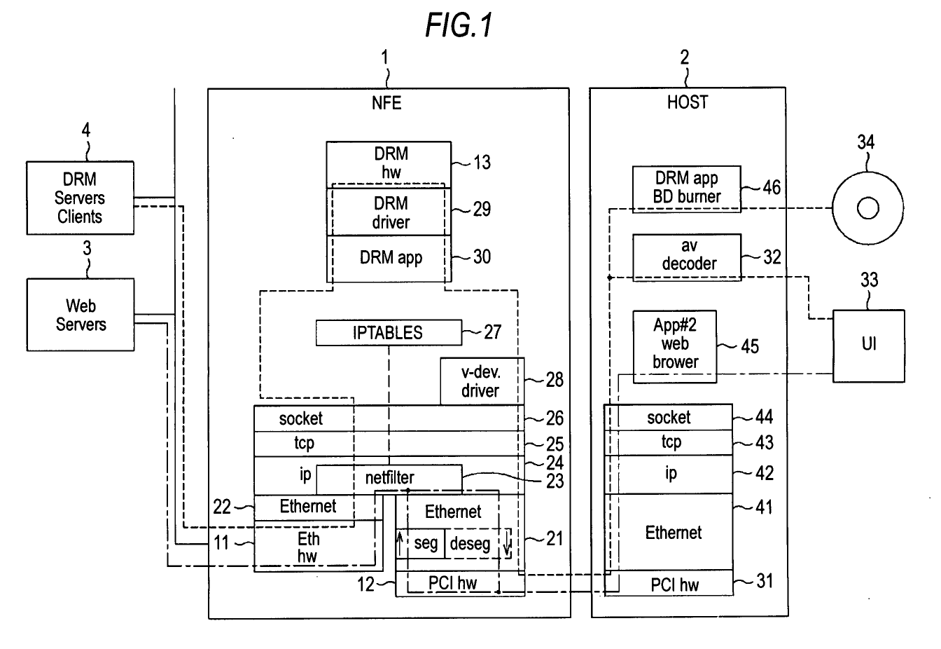

1. Whole configuration FIG. 1

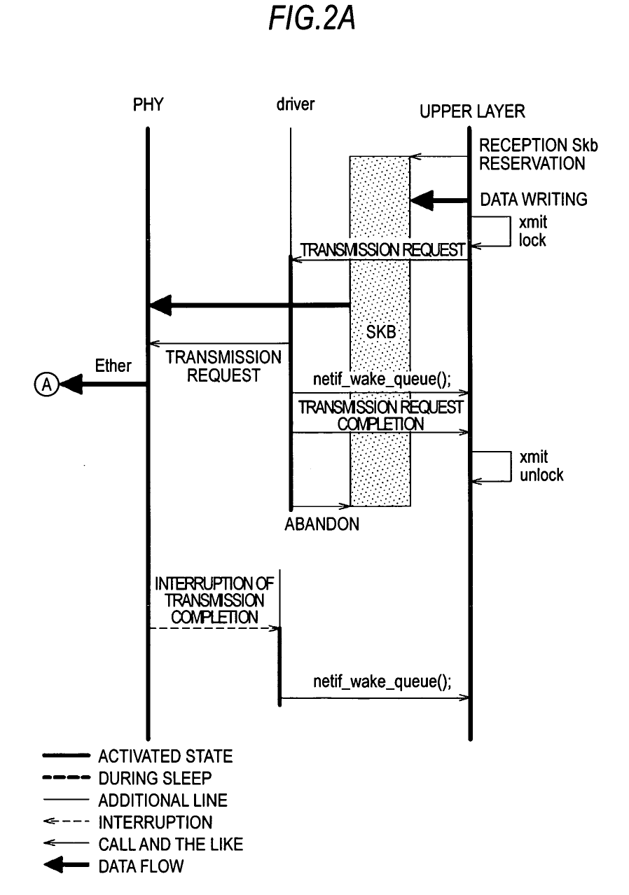

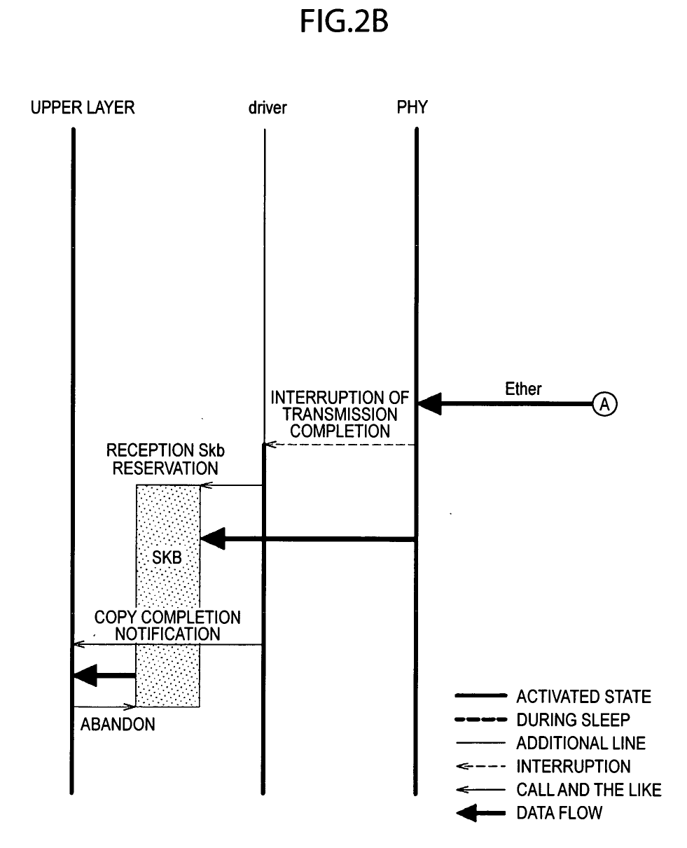

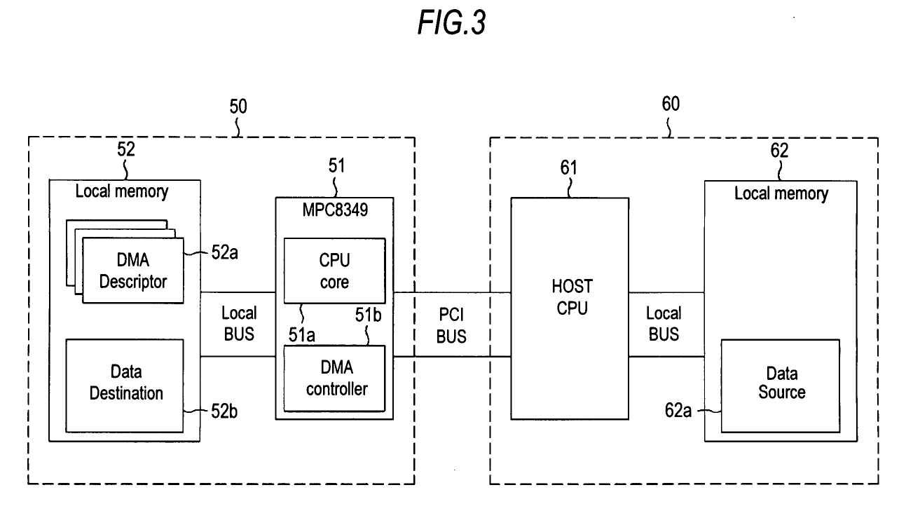

2. Communication method
2-1. Ethernet communication FIG. 2
2-2. DMA transfer FIG. 3 to FIG. 17

1. Whole Configuration

FIG. 1 is a diagram showing a configuration example of the whole network. A host device 2 to which a network front end (NFE) 1 is connected, a web server 3 and a DRM (Digital Rights Management) server/client 4 are connected to the network.

The host device 2 to which the NFE is connected functions as a DRM server, a DRM client and a web client. The host device 2 receives delivery of information from the web server 3, and also transmits and receives contents to and from the DRM server/client 4.

The web server 3 executes service programs providing display of objects such as HTML (HyperText Markup Language) and images with respect to a web browser of client software, following HTTP (HyperText Transfer Protocol).

The DRM server/client 4 issues a DRM playback key to a client as a server function, and also converts encryption by the DRM into encryption by DTCP-IP (Digital Transmission Content Protection over Internet Protocol).

Next, respective configurations of the NFE 1 and the host device 2 will be explained.

The NFE 1 includes a network connection unit 11 which is connected to the network, a bus connection unit 12 which is connected to the bus, transmitting and receiving data as well as control information and an encryption/decryption processing unit 13 encrypting contents or decrypting encrypted contents.

The network connection unit 11 performs connection to, for example, a LAN (Local Area Network) of an Ethernet (trademark) standard by wired or wireless connection. Ethernet prescribes a physical layer and a data link layer in an OSI (Open systems Interconnect) reference model. In the Ethernet, original communication data to be transmitted is divided to less than fixed lengths first, a MAC frame (Media Access Control Frame) is created and information is delivered to a transmission path in a form of the MAC frame.

The bus connection unit 12 is connected to a general-purpose bus, for example, a PCI (Peripheral Component Interconnect) bus and the like, transmitting and receiving data and control information to and from the host device 2. The bus is a line or a group of lines which can connect one or more peripheral devices at the same time, which is dealt with as a common resource. Any of devices connected to the bus is forced to act in accordance with regulations. For example, a device connected to the PCI bus has to show a bus master information such as a name, a type and a number of a multifunctional chip, a priority IRQ (Interrupt ReQuest) line, DMA (Direct Memory Access) ability. In a PCI system, data transfer is performed only between one master and one slave. The master enters into a conversation and the slave answer by data or a request.

The encryption/decryption processing unit 13 performs encryption/decryption processing of contents protected by the Digital Rights Management (DRM) technology. For example, in DTCP-IP, encryption by the DRM unique to a delivery source is converted into encryption by DTCP-IP at the time of downloading a content from the delivery source (DRM server). Accordingly, the content can be delivered to a digital device (DRM client) complying with DTCP-IP in a home LAN.

The NFE 1 includes a control unit having a ROM (Read Only Memory), a RAM (Random Access Memory), a CPU (Central Processing Unit) and the like, executing later-described integral software. Accordingly, operations of respective functions of the network connection unit 11, the bus connection unit 12 and the encryption/decryption processing unit 13 are optimized.

The host device 2 includes a device connection unit and an AV (Audio Visual) decoder 32 which are physically connected the NFE 1 through the bus. The device connection unit 31 is connected to, for example, the general-purpose bus such as the PCI bus, transmitting and receiving data and control information to and from the NFE 1. The AV decoder 32 decodes data encoded in a MPEG (Moving Picture Experts Group) system referred to as H.264/AVC.

The host device 2 includes a display control unit providing a UI (User Interface) 33 such as a graphical user interface and a recording/playback control unit performing information recording or information playback of an optical disc 34. The host device 2 includes a control unit having a ROM, a RAM, a CPU and the like, executing later-described integral software. Accordingly, the host device 2 receives supply of information from the web server 3 as well as records or plays back contents protected by the DRM.

Next, software executed by the control units of the NFE 1 and the host device 2 will be explained. Here, the software includes respective hierarchies of a user program, a socket interface, a protocol stack and a device driver in order from upper to lower layers. Explanation will be made by assuming that Linux (trademark) is used as an OS (Operation System), however, it is not limited to this and other OS such as Windows (trademark) can be used.

The hierarchy of the user program includes a DRM application 30, a web browser 45, a writing software 46 of BD (Blu-ray Disc (trademark)) with the DRM function. The user program prepares original data to be transmitted and transmits the data to the lower layer. The original data is processed in accordance with the same protocol at the transmission side and the reception side, and data processing corresponding to the protocol is performed in the lower layer.

The socket interfaces 26, 44 are logical communication ports, performing establishment and release of a virtual path for performing transmission and reception of data.

The hierarchy of the protocol stack includes IPs (Internet Protocols) 24, 42, a netfilter 23, TCPs (Transport Control Protocols) 25, 43 and the like. The hierarchy of the protocol stack is a main part for performing TCP/IP communication, performing management of connection to the other party, generation of data packets, time out or reprocessing and the like. The protocol stack also adds a MAC header or an IP header to the transmitted data.

The hierarchy of the device driver includes Ethernet drivers 21, 22 and 41, a DRM driver 29 and the like. The Ethernet driver 21 controls the network connection unit 11, the Ethernet driver 22 controls the bus connection unit 12 and the Ethernet driver 41 controls the device connection unit 31 and the DRM driver 29 controls the encryption/decryption processing unit 13, respectively.

In the embodiment, the Ethernet drivers 21, 41 performing communication between the NFE 1 and the host device 2 are mounted both at the NFE 1 and the host device 2. The network device drivers are mounted as device drivers having kernel interfaces, working as lower layers of respective IP layers of the NFE 1 and the host device 2. The device drivers for performing communication of the PCI bus between the NRE 1 and the host device 2 are mounted in the form of the Ethernet device drivers instead of dedicated drivers for both applications in this manner, therefore, the both applications can use the socket interfaces, NAPI (New API) and the like as an intermediate layer. NAPI switches the driver operation from an interrupt driven to a polling driven when high load is imposed on the network, thereby preventing reduction of response ability of the whole system under the network load.

When the web browser 45 of the host device 2 communicates with the web server 3, the host device 2 performs the PCI bus communication through respective layers of the socket interface 44, the TCP 43, the IP 42 and the Ethernet driver 41 and the device connection unit 31. The web server 3 communicates with the host device 2 through the PCI bus, the bus connection unit 12, the Ethernet driver 21, the netfilter 23 and the Ethernet driver 22 and the network connection unit 11 at the NRE 1 side.

Here, IP packet transfer, IP address translation and the like are performed by functions such as the netfilter 23 and the like. As the IP packet transfer function, for example, the netfilter 23/IPTABLES 27 of Linux can be used. Accordingly, the host device 2 can communicate with an external network. The host device can also communicate with the external network using a fixed private IP address by using a NAT (Network address translation) in the netfilter 23 and the like. In the case that it is necessary to notify an IP address for the outside to the host device 2 or to perform setting at the NFE 1 side from the host device 1, processing can be performed easily through the communication of the virtual network described above. It is also possible that security functions and the like can be mounted in the NFE 1 by using an IP filtering function.

When the AV decoder 32 with the DRM function or the writing software 46 of the host device 2 performs communication with the DRM server/client 4, the host device 2 performs the PCI bus communication through respective layers of the socket interface 44, the TCP 43, the IP 42 and the Ethernet 41 and the device connection unit 31. The DRM application 30 communicates with the host device 2 through the PCI bus, the bus communication unit 12, the Ethernet driver 21, the IP 24, the TCP 25 and the socket interface 26 at the NFE 1 side. Then, encryption or decryption of content data is performed by the DRM application 30, the DRM driver 29 and the encryption/decryption processing unit 13.

Since the DRM application 30 is a multi-process application, or for some other reasons, a used portion of the socket interface 26 is shielded in a kernel driver to be a virtual device driver 28 which performs the DRM communication. Accordingly, it is possible to perform mutual exclusion using a kernel object easily.

The DRM application 30 of the NFE 1 communicates with the DRM server/client 4 through the socket interface 26, the TDP 25, the IP 24, the netfilter 23, the Ethernet driver 22 and the network connection unit 11.

As described above, device drivers for data-link layer interfaces are mounted as Ethernet device drivers at both sides of the NFE 1 and the host device 2 which are connected by the general-purpose bus such as the PCI, which allows the NFE 1 to have functions such as the IP transfer and the NAT. Accordingly, it is possible to realize both a DRM offloading function which is a primary function of the NEF and a general-purpose network access as well as to provide these functions to the host device 2 efficiently. That is, both the communication between the DRM applications and the general-purpose network access can be realized easily.

### 2. Communication Method

Next, communication of the network device drivers will be explained. Here, general Ethernet communication will be explained first, then, DMA transfer will be explained subsequently.

### 2-1. Ethernet Communication

The network device driver is positioned at the lowest layer of software as a layer lower than the protocol stack for the network, receiving and giving data from the upper protocol layer or data from devices in the physical layer. In Linux, the giving and receiving of data is realized between the network device driver and the upper protocol layer by a socket buffer (SKB).

A buffer given from the upper protocol or given to the upper protocol has a format unique to Linux, which is called the socket buffer. The socket buffer is a structure, having a data portion and a member storing attributes. In data flow performed in the driver, data transfer between the socket buffer and devices will be a main job.

As important information for the network device driver in information stored by the socket buffer, there are a header pointer (head), a data pointer (data) and a tail pointer (tail). The header pointer corresponds to the head of a frame header stored in the socket buffer. The data pointer indicates the header of data in the frame and the tail pointer indicates the end of the frame stored in the socket buffer. These pointers are operated to thereby designate the length of data to be transmitted or received and realize a simple interface.

FIG. 2A and FIG. 2B are diagrams showing a communication method of Ethernet. At the time of transmission, an Ethernet frame is formed in the upper IP layer as shown in FIG. 2A. The network device driver checks whether there is space in a transmission buffer on the device or not, and when there is no space, the driver marks that the data is processed later. When there is space, the driver copies the frame in the device and issues a transmission request to the device. The network device generates interruption to the driver at the time of transmission completion or an error.

On the other hand, at the time of reception, when the frame is received on the device as shown in FIG. 2B, an interruption to the network device driver is generated by the device. The network device driver reserves a reception SKB by the interruption, copying the frame from the PHY reception buffer to the reception SKB. After the copy, the driver transmits the frame to the upper protocol to complete the reception.

In the embodiment, the NFE 1 and the host device 2 are directly connected in a close manner, which realizes an environment in which effects by external noise and the like can be ignored. For example, it is possible to omit various checksum calculations in the IP header, the TCP and the like. These can be realized easily by declaring that the checksum is not used for the kernel.

Since the NFE 1 and the host device 2 are directly connected in a close manner, it is possible to reduce CPU load necessary for network processing by the byte by increasing the size of the socket buffer or a packet as large as possible. Commonly, a value such as 1500 bytes is empirically used as a MTU (Maximum Transmission Unit) for the actual network interface based on the necessity of fixing the upper limit of the size which can be dealt with by the devices on the network through which the packet passes such as a hub and a router, or the host device of the other party. However, the embodiment realizes the environment in which effects by the external noise and the like can be ignored, therefore, the MTU can be enlarged as long as the kernel resource allows.

The network device driver which connects the NFE 1 and the host device 2 are mounted as described above, thereby preventing itself from being the CPU load, further, reducing network processing load of the host device 2.

2-2. DMA transfer

Since the NFE 1 and the host device 2 are directly connected in the embodiment, it is possible to perform transmission and reception exceeding the MTU which is set by itself due to the DMA transfer. A DMA function is a function in which a DMA controller performs data movement (data transfer) from a specific address on a memory space attached to the bus to a specific address on a memory space attached to the same bus without interposition of the CPU.

At the time of DAM processing which is described later, data transfer between memory regions is controlled by reading a descriptor which is attribute information concerning data transfer such as a data transfer address and a transfer size from a descriptor storage region in an external memory to a DMA register block in the DMA controller. When the DMA is activated, the DMA controller reads data written in the DMA register block (the memory address and the transfer data size), performing reading control of data of transfer data size from a transfer source address in the memory region and transmitting the data to the memory of a transfer destination through the PCI bus.

In the kernel such as Linux, flags and the like which declare a support for a TPO (TCP Segmentation offloading) are prepared. Accordingly, the kernel can give the socket buffer exceeding the MTU size to the Ethernet device driver and can allow the Ethernet device driver to transmit the buffer in a divided manner.

The Ethernet device driver of the host device 2 side declares the support of the ISO to the kernel to thereby perform transmission at the actual transmission to the NFE 1 without performing dividing processing (segment processing), ignoring the MTU size. Accordingly, it is possible to reduce the CPU load by the byte necessary for the TCP checksum recalculation or reconstruction of the DMA descriptor.

The Ethernet device driver of the NFE 1 side also declares the support of the ISO to the kernel to thereby perform transmission at the actual transmission to the host device 2 without dividing the packet in the same manner as the processing of the host device 2 side.

At the time of transmission to the host device 2, it is effective that “small packets from the external network through the netfilter” are collected to make one large packet. However, this function is not mounted on the netfilter at present because the operation of the TCP layer is fundamentally necessary. When the function is performed by using a scatter/gather DMA in cooperation with the netfilter and the Ethernet device driver in the future, hardware which can perform recalculation in parallel with the DMA is used because checksum recalculation of the IP header and the TCP becomes necessary.

Additionally, particularly in the Ethernet driver of the NFE 1 side, the segment processing may be performed in parallel with the communication between the NFE 1 and the host device 2 at a time. At the time of reception from the host device 2, the packet is divided so as to correspond to the MTU of an actual network interface for the outside. Specifically, the packet is divided in parallel with the reception by simple processing such as generation of the DMA descriptor by using the scatter/gather DMA simultaneously at the time of reception through the PCI bus. At this time, the hardware which can perform recalculation in parallel with the DMA is used because the checksum recalculation of the IP header and the TCP becomes necessary.

Next, the DMA transfer will be explained in detail. FIG. 3 is a block diagram showing a configuration example of bus communication between the NFE and the host device. In the configuration example, an NFE control unit 50 is connected to a host control unit 60 through the PCI bus. In the NFE control unit 50, a processor 51 is connected to a local memory 52 through a local bus, and data is stored in the local memory 52 based on a descriptor executed at the processor 51. As the processor 51, for example, a power PC processor “MPC 8349” manufactured by Freescale Semiconductor can be used. Also in the host control unit 60, a processor (host CPU) 61 and a local memory 62 are connected through a local bus in the same manner as the NFE control unit 50.

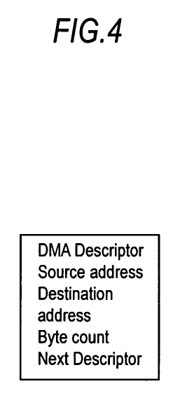

FIG. 4 is a view showing a description example of the DMA descriptor. When data is transferred from the host control unit 60 to the NFE control unit 50, a CPU core 51a requests the start of DMA by notifying an address of a DMA descriptor 52a to a DMA controller 51b. The DMA controller 51b reads the DMA descriptor and moves data of a data source 62a in the local memory 62 to a data destination 52b in the local memory 52 based on a source address and a destination address. After the transfer is completed, the DMA controller 51b reads a next DMA descriptor based on a next descriptor address described in the DMA descriptor.

In the example shown in FIG. 3, the descriptor is in the local memory 52 of the NFE control unit 50 side, however, it is also preferable that the descriptor is in the local memory 62 of the host control unit 60 side. In this case, an address in the local memory 62 of the host control unit 60 side may be designated as a position of the descriptor, instead of the address of the local memory 52, when the DMA is started.

In the embodiment, in order to disguise the PCI communication as network communication, the host control unit creates a TxBD/RxBD (Tx/Rx buffer descriptor) for network communication on the local memory 62, instead of the DMA descriptor for the PCI communication, so that the communication is realized in a form close to the normal Ethernet device driver. On the other hand, the NFE control unit 50 creates the DMA descriptor for the PCI communication on the local memory 52, writing an address of the buffer by itself. An address of the local memory 62 of the host side is written by reading the TxBD/RxBD created by the host control unit 60. Accordingly, the device driver of the NFE side processes (imitates operations of PHY) so as not to conflict with the Ethernet device driver of the host side as well as performing the DMA processing while interfacing with the network layer of the host control unit 60.

Here, initialization processing will be explained first, then, simple DMA transfer and multiple transfer will be explained subsequently.

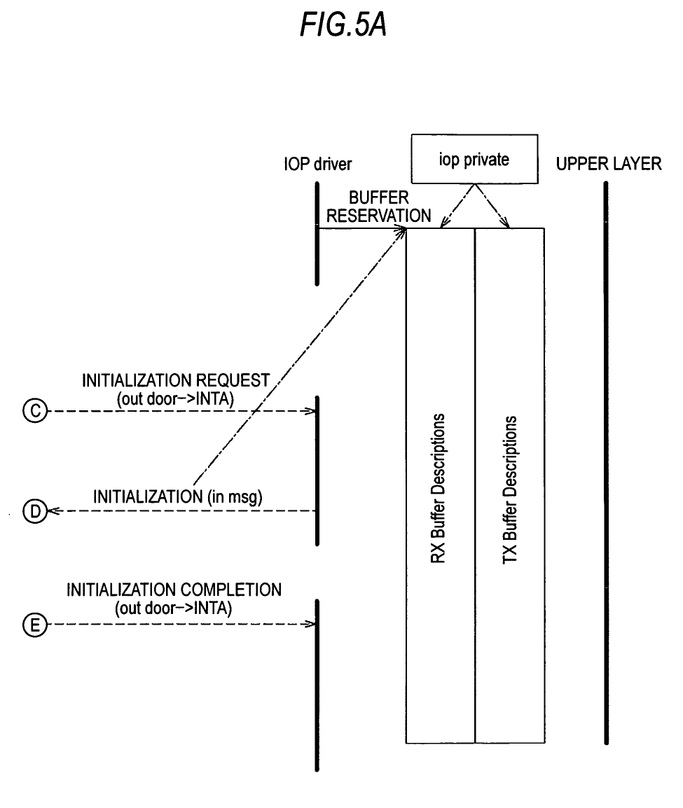

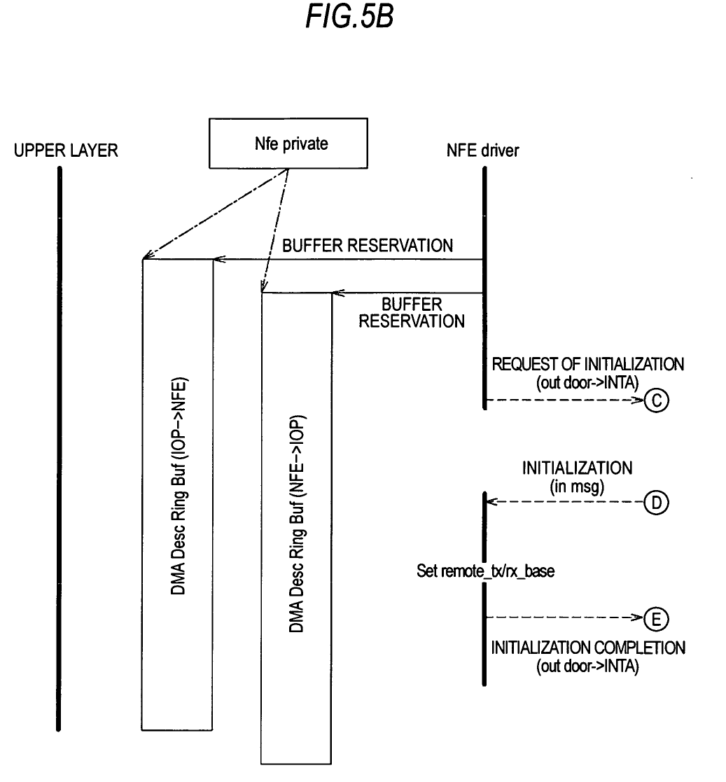

FIG. 5A and FIG. 5B are diagrams showing initialization processing of the DMA transfer. The processor 61 of the host control unit 60 side is a PCI master and the processor 51 of the NFE control unit 50 side is a slave. That is, the DMA is set up in the DMA controller 51 of the NFE 1. In the following description, the processor 61 of the host control unit 60 side is referred to as an IOP (input/output processor) and the processor 51 of the NFE control unit 50 side is referred to as an NFE.

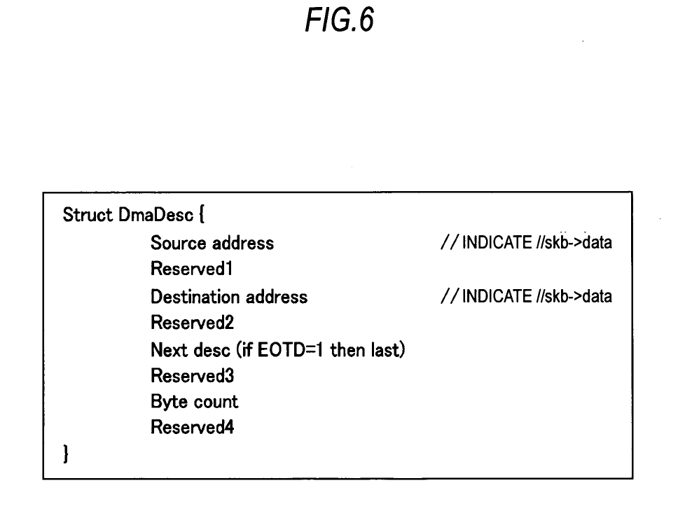

FIG. 6 is a view showing a description example of DMA descriptor definition. According to the DMA descriptor definition, it is possible to form a ring buffer by using “Next desc”. It is also possible to perform transfer efficiently by using a DMA chain mode.

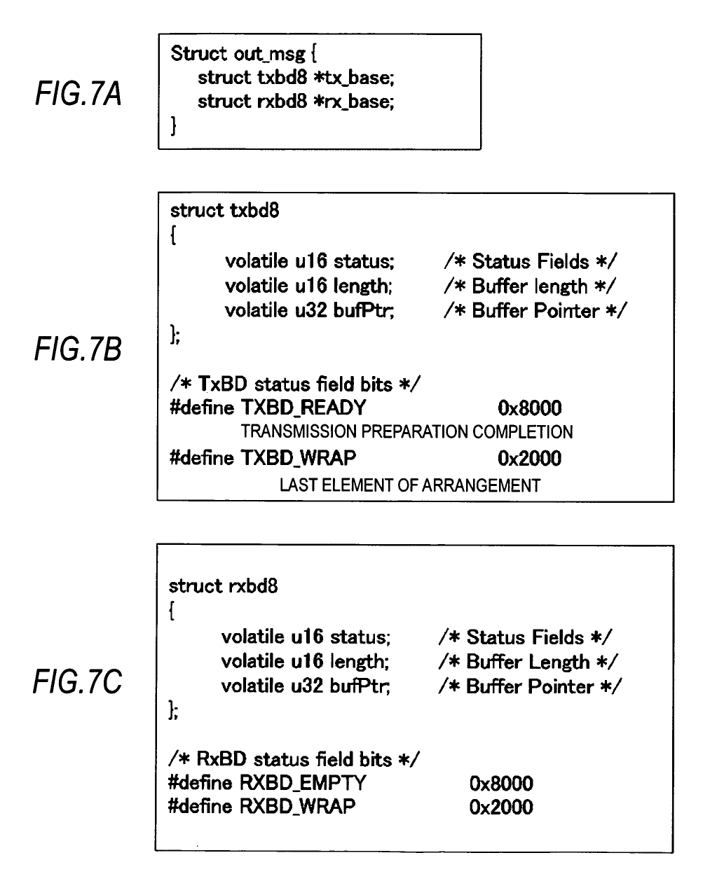

FIG. 7A to FIG. 7C are views showing description examples of Tx/Rx buffer descriptor definition. According to the Tx/Rx buffer descriptor definition, the Tx/Rx buffer descriptor is formed at the IOP side and the NFE performs reading and writing through the PCI bus.

Here, notification from the NFE to the IOP is performed by outbound doorbell-INTA, and types of messages are distinguished by a number of doorbell. On the other hand, notification from the IOP to the NFE is performed by inbound doorbell, and types of interruption are distinguished by a number of doorbell.

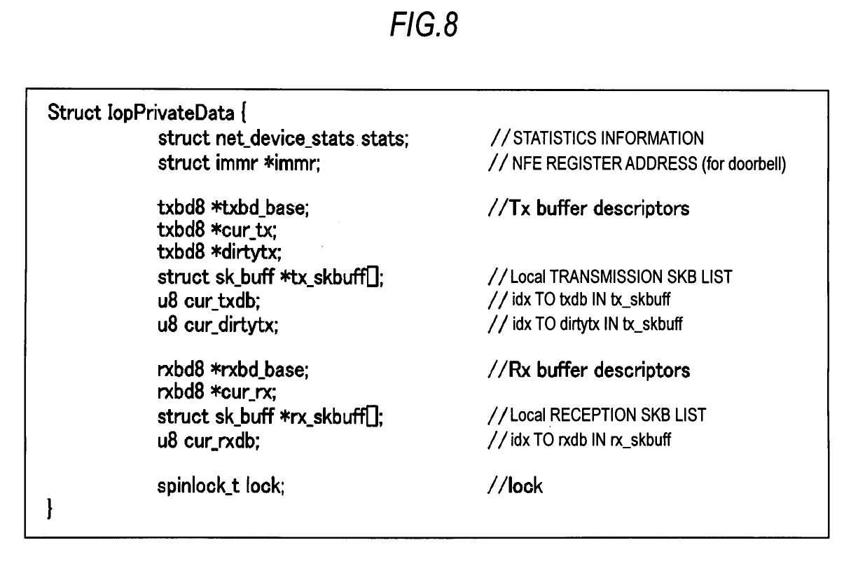

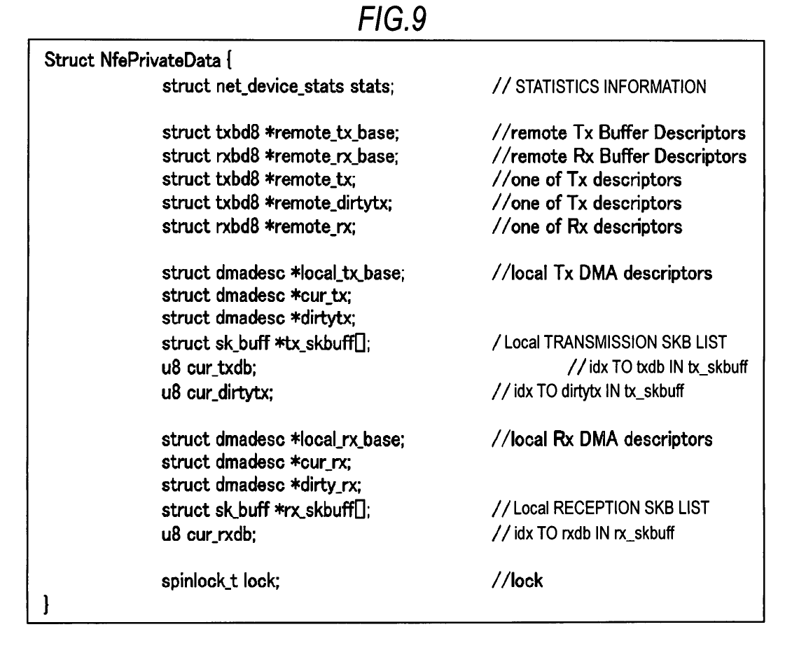

FIG. 8 is a view showing an example of specific data of the IOP and FIG. 9 is a view showing an example of specific data of the NFE. At the time of initialization, the IOP reserves a Tx buffer descriptor based on the IOP specific data as shown in FIG. 8, and the NFE reserves a specific DMA descriptor ring buffer for reception based on the NFE specific data as shown in FIG. 9. The ring buffer is not accessed from the IOP.

The IOP notifies an address of the reserved Tx buffer descriptor to the NFE, and the NFE reads the Tx buffer descriptor of the IOP and completes it. The NFE also reserves a specific DMA descriptor ring buffer for transmission and notifies an initialization request as an interruption message (outdoor-INTA) to the IOP. The IOP notifies the initialization of the interruption message (in msg) to the NFE, reserving an Rx buffer descriptor. The NFE sets “Set remote_tx/rx_base” with respect to the initialization (in msg) and notifies initialization completion (outdoor→INTA) to the IOP. According to the above, the initialization is completed.

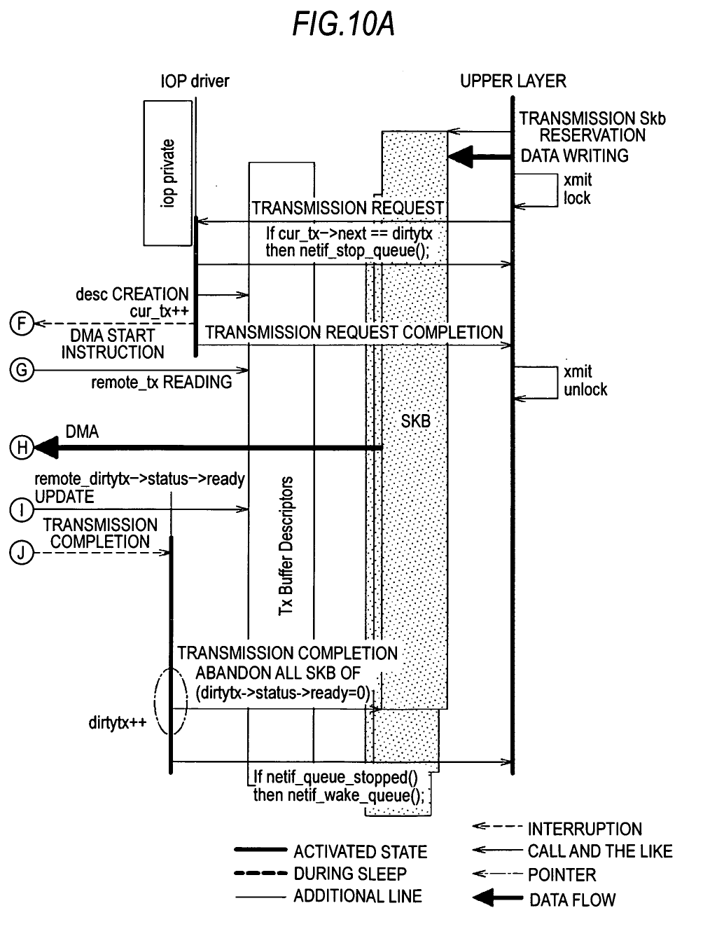

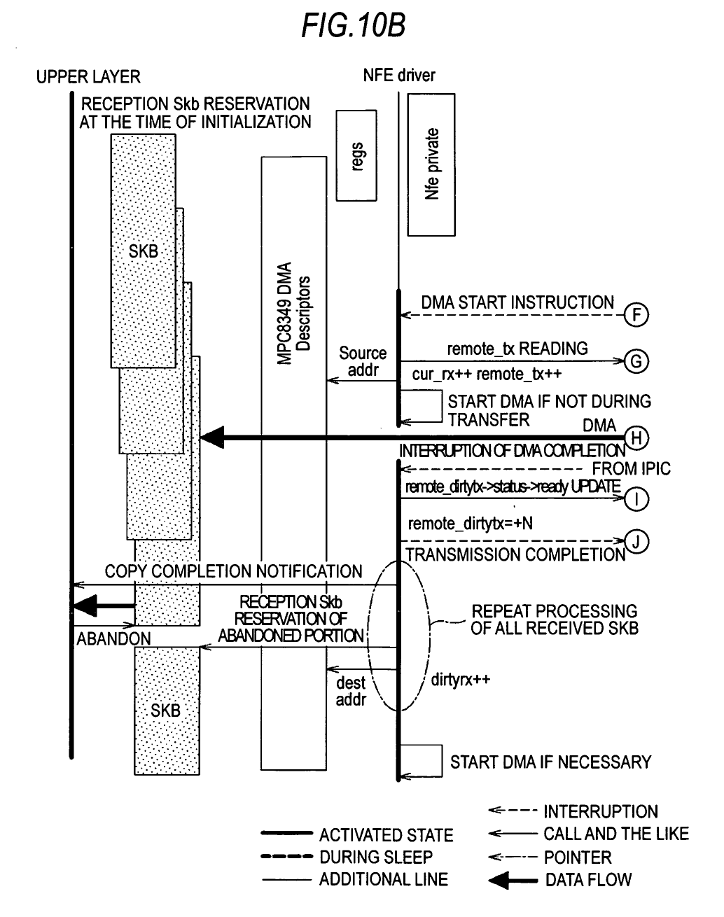

FIG. 10A and FIG. 10B are diagrams showing processing the simple DMA transfer. Here, in a “feature” setting of the IOP driver, NETIF_F_TSO, NETIF_F_SG, NETIF_F_FRAGLIST is set to be OFF. That is, declaration of not supporting the TSO (TCP segmentation offloading) is performed to the kernel.

The protocol of the upper layer of the transmission side reserves a reception socket buffer (SKB), writing transmission data and performs transmission request to the IOP driver. The transmission data includes a data pointer and the size of the SKB.

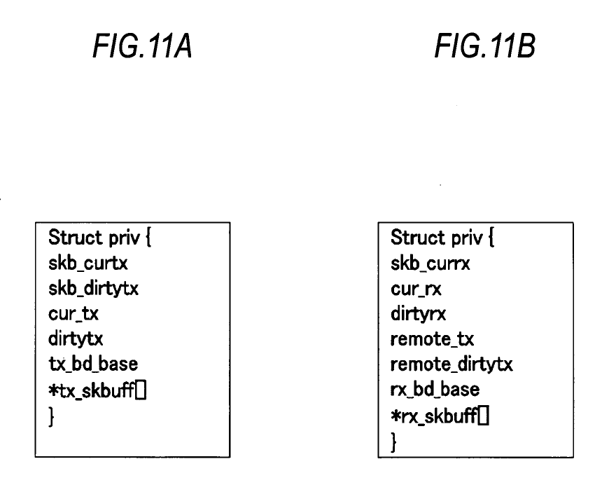

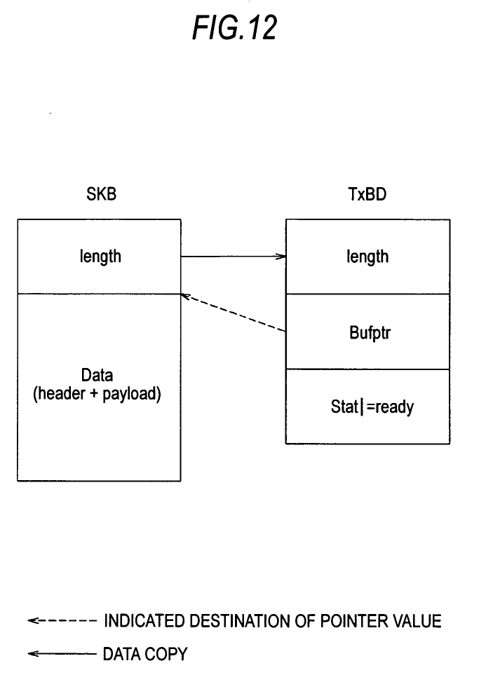

The IOP driver reserves the TxBD buffer according to a specific data example of the IOP shown in FIG. 11A. The IOP driver sets a data pointer of the SKB as a TxBD buffer pointer with respect to the transmission request as shown in FIG. 12. The driver also sets the size in the TxBD to allow status of TxBD to be in a transmission ready state. The IOP driver instructs the DMA start, notifying the transmission request completion to the upper layer.

On the other hand, the driver of the NFE reserves the DMA descriptor buffer according to a specific data example of the NFE shown in FIG. 11B. Then, the driver reads the descriptor of the IOP and acquires a source address when receiving the DMA start designation.

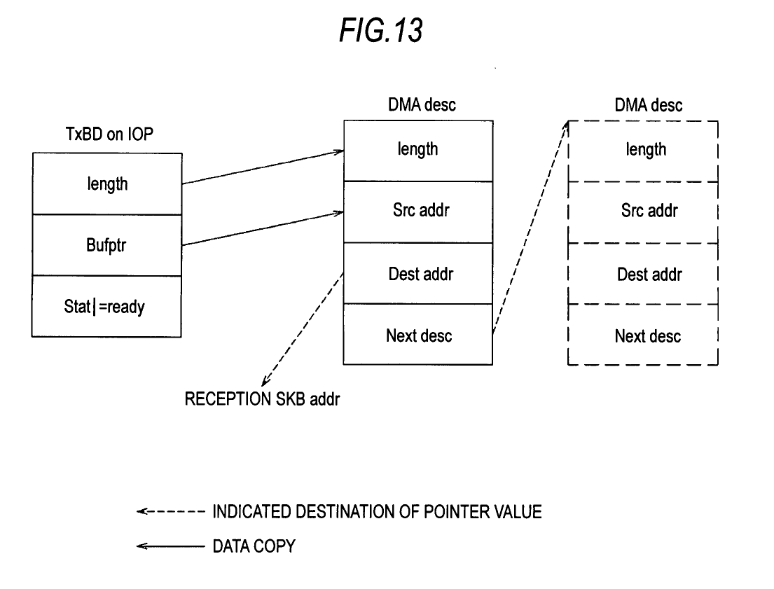

Specifically, the driver performs setting as shown in FIG. 13 with respect to the TxBD of the IOP in the transmission ready state. The driver reads the buffer pointer from TxBD of the IOP, setting the pointer in “srd addr” of the DMA descriptor. Next, the SKB pointer reserved at the time of initialization is set in “dst addr” of the DMA descriptor. Next, the size read from the TxBD is set in “length” of the DMA descriptor and a pointer to a next DMA descriptor is set in “next desc”. Then, “EORD flag” is set in “next desc” of the last DMA descriptor.

Next, the driver of the NFE starts the DMA transfer if another DMA transfer is not performed. Here, all SKBs in “remote_tx>ready flag=1&dirtyrx<cur_rx” are transferred.

After the transfer ends, DMA completion is notified to the NFE driver in an interrupted manner by the IPIC. The NFE driver updates the descriptor (remote_dirtyrx->status->ready) and notifies the IOP driver of the transmission completion (remote_=+N). Here, in the case of “dirtyrx=cir_rx−1, notification is performed after the reception buffer is reserved.

The NFE driver performs copy completion notification to the protocol of the upper layer. Receiving the copy completion notification, the protocol of the upper layer of the NFE side receives data from the socket buffer of reception and abandons the socket buffer after that. The NFE driver reserves the socket buffer for reception for the abandoned portion. These processes are performed with respect to all received socket buffers repeatedly.

The IOP driver abandons all socket buffers in the transmission completion (dirtytx->status->ready=0) when receiving notification of transmission completion from the NFE driver.

The simple DMA transfer is performed as described above, thereby transmitting data of one packet as one DMA descriptor and disguising the PCI communication as the network communication.

Next, multiple transfer will be explained. In the multiple transfer, data of one packet is transmitted in the chain mode of plural DMA descriptors. When the TSO (TCP Segmentation offloading) is ON, the buffer transmitted from the upper layer is not one large buffer but is divided into plural Fragment buffers. However, a TCP/IP header is one whole large buffer exceeding the MTU.

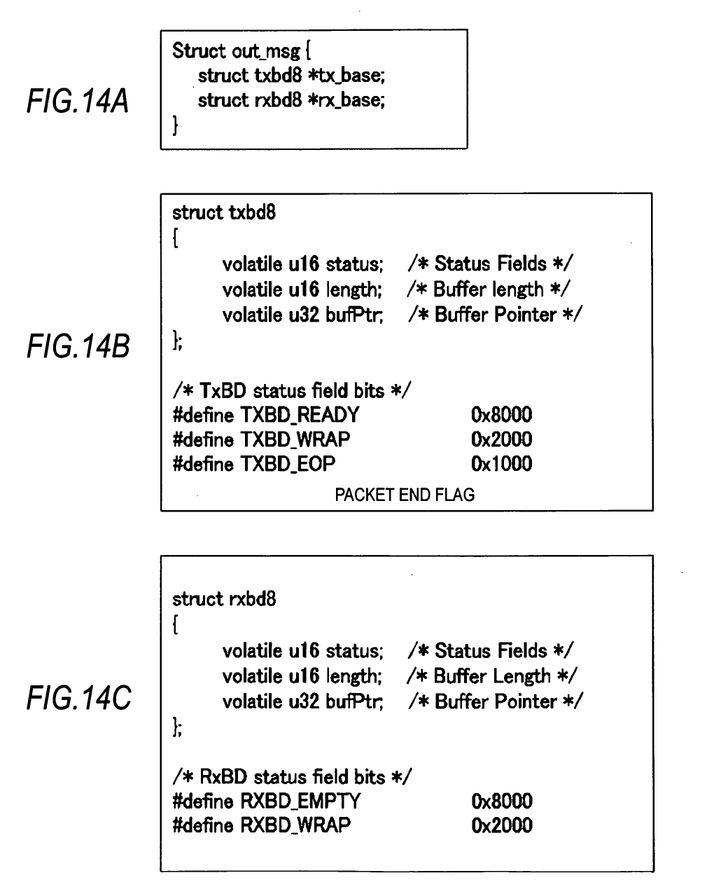

FIG. 14A to FIG. 14C are views showing description examples of the Tx/Rx buffer descriptor definition. Though the Tx/Rx buffer descriptors are used as information transmission from the IOP to the NFE, they do not correspond to part of statuses. The Tx/Rx buffer descriptors are formed in the IOP side, and the NFE side performs reading and writing through the PCI. Additionally, a packet end flag (EOP) is added as shown in FIG. 14B.

First, in the feature setting of the IOP driver, TSO, SG and FRAGLIST are made to be ON. That is, declaration of supporting the TSO (TCP Segmentation offloading) is performed to the kernel.

In the TSO, the size of the SKB reception buffer of the NFE side is different, for example, in the case that the host device 2 performs communication with the DRM application in the NFE 1 (use case 1) and in the case that the host device 2 performs communication with the web server 3 and the like through the netfilter 23 (use case 2) as described later.

In the use case 1, the data size transmitted in the ISO is made to be the reception buffer size because it is desirable that the data is transmitted to the DRM application of the NFE side by maintaining the size as large as possible. To reserve a too large buffer at a time may cause reduction of performance, therefore, a fixed upper limit value can be provided.

In the use case 2, it is desirable that data is transferred as it is without changing (dividing and combining) the MTU size in the Netfilter 23, therefore, the MTU size is made to be the reception buffer size. That is, the MTU size of the external Ethernet communication and the MTU size of the PCI communication are set to be the same value.

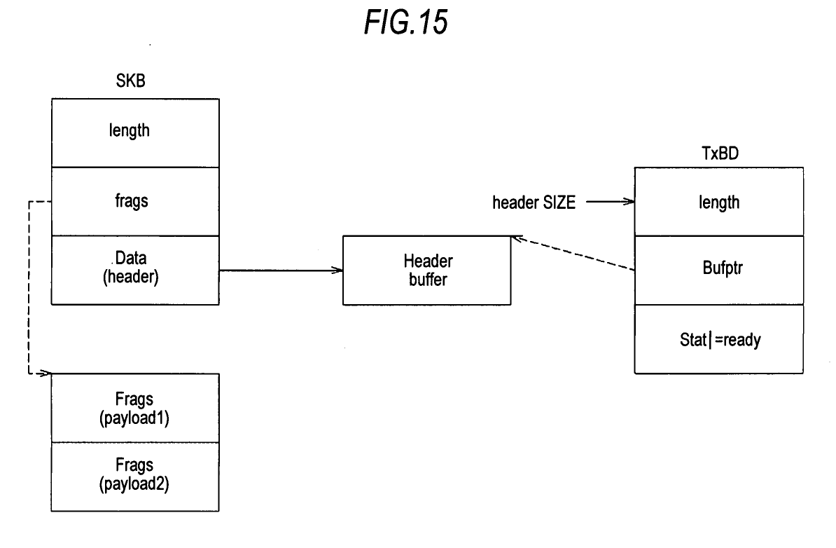

The protocol of the upper layer of the transmission side reserves the reception socket buffer (SKB), writing transmission data and performs transmission request to the IOP driver. The transmission data includes the data pointer and the size of the SKB. Additionally, data is divided into fragments as shown in FIG. 15.

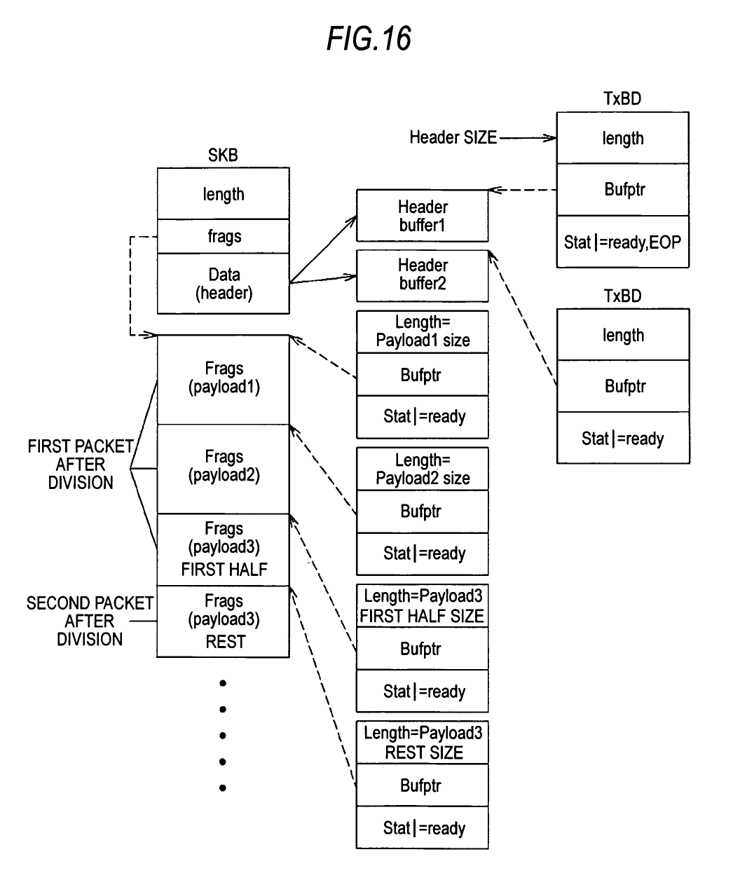

The IOP driver repeats operations shown in FIG. 16 until the creation of TxBD is completed to transfer the whole data of the SKB. First, the IOP driver creates a TxBD for a header. Specifically, the IOP driver reads header information from the first SKB data pointer, copying the information in another region (headp) and rewriting size/checksum in the “headp” so as to correspond to the divided packet. Next, the driver sets the “headp” as a TxBD buffer pointer. Then, the driver sets the head size in the TxBD to allow status of TxBD to be the transmission ready state.

Next, the IOP driver creates a TxBD for payload. Specifically, the following operations will be repeated until the creation of TxBDs of the divided packet size is completed as shown in FIG. 16. First, “rest_size” is allowed to be the divided packet size only at the first packet. The “rest_size” indicates the size of packet data which has been not transferred in the divided packet data.

Here, when remaining data of “frag” is smaller than the “rest_size”, namely, when a data of next “frag” is necessary to complete data of the divided packets, an address next to data written in the previous TxBD is set as the TxBD buffer pointer (a head of the next “frag” in most cases). The remaining data size of “frag” is set in “length” of the TxBD, and the TxBD status is made to be the transmission ready state. Then, “length” is subtracted from “rest_size”.

On the other hand, when the remaining data of “frag” is larger than “rest_size”, namely, in the case of the last TxBD of the divided packets, an address next to data written in the previous TxBD is set as the TxBD buffer pointer (a head of the next “frag” in most cases). Then, the remaining data size of “frag” is set in “length” of the TxBD, and the TxBD status is made to be the transmission ready state as well as the “EOP flag” is set. Then, “length” is subtracted from “rest_size”.

As described above, the repetition of the divided one packet ends. The above transfer is repeated with respect to all SKB data.

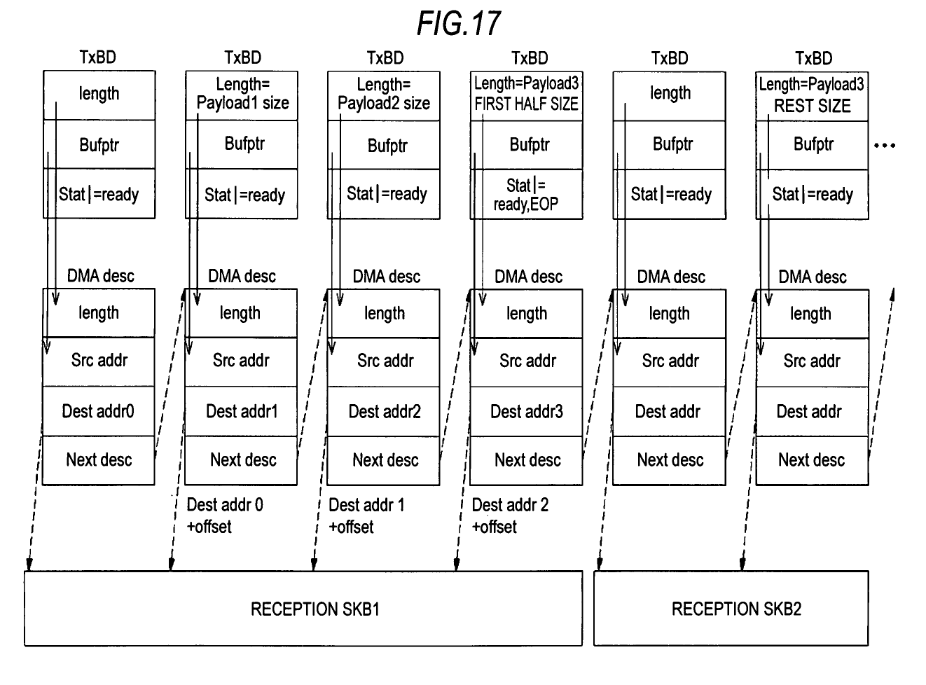

Next, reception operations of the NFE will be explained. The NFE driver repeats processing as shown in FIG. 17 with respect to TxBD of the IOP in the transmission ready state. “offset” is set to be “0” only at the first time. The “offset” indicates the used size of the SKB for reception.

First, a buffer pointer is read from the TxBD of the IOP to be set in “src addr” of the DMA descriptor. Also, a SKB pointer +offset reserved at the time of initialization and the like is set in “dst addr” of the DMA descriptor. Next, the size read from the TxBD is set in “length” of the DMA descriptor. Then, a pointer for the next DMA descriptor is set in “next desc” (Offset+=length). When EOP of the TxBD status is set, offset is made to be “0” and the SKB pointer for reception is allowed to proceed to the next. Accordingly, an EOTD flag is set in “next desc” of the last DMA descriptor. After that, DMA start is instructed.

As described above, the declaration of supporting the ISO (TCP segmentation offloading) allows the kernel to transmit the socket buffer exceeding the MTU size to the Ethernet device driver as well as allows the Ethernet device driver to transmit data in a divided manner.

Next, two use cases in the multiple transfer will be explained. As described above, the size of the SKB reception buffer of the NFE side is different in the case that the host device 2 performs communication with the DRM application 30 in the NFE 1 (use case 1) and in the case that the host device 2 performs communication with the web server 3 and the like through the netfilter 23 (use case 2).

When the host device 2 performs communication with the DRM application 30 in the NFE 1 (use case 1), it is desirable that transfer is performed at a time by making the unit of DMA as large as possible.

MTU size≦DMA transfer size≦TSO data size

Here, the DMA transfer size is the transfer size of the sum of descriptors connected in the DMA chain mode. The size transferred by one DMA descriptor is smaller than the above size.

The reception buffer size of the Ethernet device driver is commonly determined by the MTU size, however, the transfer size exceeds the MTU size in this case, therefore, it is difficult to reserve the reception buffer of the sufficient size by the normal method. Accordingly, in order to respond to the above, the Ethernet device driver reserves the reception buffer not by using the MTU size but by using data size of the TSO. However, to reserve a too large buffer at a time may cause reduction of performance by contrast, therefore, a fixed upper limit value can be provided.

On the other hand, when the host device 2 performs communication with the web server 3 and the like through the netfilter 23 (use case 2), the DMA transfer is performed by forming the TCP/IP header so as to correspond to the MTU size of the Ethernet driver of the external communication side. In this case, the MTU size which is the same as the MTU size of the Ethernet for external communication is set also to the driver with respect to the PCI communication. Accordingly, the reception buffer size can be determined by the normal method (based on the MTU size) at the reception side, therefore, it is possible to perform transmission in the large data size to the Ethernet device driver for external communication in the host device 2 side. The TCP/IP header may be added either in the NFE side or in the host device 2 side. It is also preferable to perform the transfer more rapidly by using hardware which performs checksum calculation and the like.

When the above two use cases 1, 2 are realized at the same time, it is possible to use the both properly by mounting two pairs of drivers corresponding to respective use cases and two network interfaces are provided in both sides of the NFE 1 and the host device 2 respectively.

Specifically, the following four drivers are mounted.

| | |
|---|---|
| Host device side driver | iopl (for use case 1), |
| | iop2 (for use case 2) |
| NEF side driver | nfel (for use case 1), |
| | nfe2 (for use case 2) |

When these are installed in Linux, two interfaces are added. For example, assume that there are only the following two interfaces.

>ifconfig

eth0 XXXXXXX (normal Ether interface)

lo0 YYYYYY (local loop interface)

Drivers for the use cases 1, 2 are mounted.

>insmod iop1.ko
>insmod iop2.ko
>ifconfig eth1 AAA.AAA.AAA.AAA
>ifconfig eth2 BBB.BBB.BBB.BBB
>ifconfig
eth0 XXXXXXX (normal ether interface)
eth1 AAAAAAA (PCI communication interfade for Use Case 1)
eth2 BBBBBBB (PCI communication interfade for Use Case 2)
1o0 YYYYYY (local loop interface)

The drivers for the use cases 1, 2 are mounted also to the NFE side. Then, network IP addresses which are different from each other are assigned to eth1, eth2, thereby properly using the use cases 1, 2 without difficulty.

That is to say, the network device drivers are mounted on both sides according to the use case, and the host device 2 designates a network IP address assigned to a virtual interface of each network device driver, thereby selecting communication with an external device connected to the network or communication to an encryption/decryption application.

As described above, since the NFE acts for the specific network function and the DRM function, it is possible to reduce the load of the main CPU necessary for network processing, encoding, decoding, conversion and the like of the DRM (encryption) such as DTCP-IP and Marlin in the host device. Therefore, high-speed processing can be realized and plural simultaneous processing of high-definition contents can be performed.

Additionally, the host device can perform general-purpose network communication to the outside and the DRM communication at the same time through the virtual network interface when not having the driver and the like for the actual network device.

Furthermore, the NFE can make hardware (register configuration and the like) and NFE-side software so that the NFE is seen as a normal NIC (network card) by the host device or similar to the NIC. Accordingly, the driver of the host side can be configured similar to a normal driver for the network card, which reduce development costs because codes can be appropriated.

An example of the embodiment has been explained as the above, however, the invention is not limited to the above embodiment and various modifications can be performed based on technical ideas. For example, in the above embodiment, the PCI bus is used as a general-purpose bus, however, it is also preferable to use an ISA (Industry Stand and Architecture) bus or an EISA (Extended Industry Standard Architecture) bus. It is further preferable that the NFE has plural network IFs and has plural unique functions in a composite manner such as performing routing.

It should be understood by those skilled in the art that various modifications, combinations, sub-combinations and alterations may occur depending on design requirements and other factors insofar as they are within the scope of the appended claims or the equivalents thereof.

What is claimed is:

1. A network adapter comprising:
a network connection unit which is connected to a network, transmitting and receiving packet data;
a bus connection unit which is connected to a bus, transmitting and receiving data and control information to a host device;
an encryption/decryption processing unit executing an encryption/decryption application which encrypts contents or decrypts the encrypted contents; and
a control unit executing software including respective hierarchies of a socket interface, a protocol stack and a device driver, and
wherein the encryption/decryption application performs communication with the network connection unit or the bus connection unit through the socket interface, and
wherein the control unit controls transmission and reception of data and control information of the bus connection unit by using a network device driver as the device driver.

2. The network adapter according to claim 1,
wherein a virtual device driver which shields the socket interface is interposed between the socket interface and the encryption/decryption application.

3. The network adapter according to claim 1,
wherein the network device driver segments transmission data and transmits the data to the host device.

4. The network adapter according to claim 1,
wherein the network device driver declares a support of a TSO (TCP Segmentation offloading) and transmits transmission data without segmenting the transmission data.

5. The network adapter according to claim 1,
wherein the network device driver performs communication with the host device by using a MTU (Maximum Transmission Unit) value of 1500 bytes or more.

6. A communication device comprising:
a network adapter including a network connection unit which is connected to a network, transmitting and receiving packet data, a bus connection unit which is connected to a bus, transmitting and receiving data and control information to a host device, an encryption/decryption processing unit executing an encryption/decryption application which encrypts contents or decrypts the encrypted contents and a network control unit executing software including respective hierarchies of a socket interface, a protocol stack and a device driver; and
a host device including a device connection unit connected to the network adapter through the bus and a host control unit executing software including respective hierarchies of the socket interface, the protocol stack and the device driver, and
wherein the encryption/decryption application performs communication with the network connection unit or the bus connection unit through the socket interface, and
wherein the network control unit and the host control unit control transmission and reception of data and control information between the bus connection unit and the device connection unit by using a network device driver as the device driver.

7. The communication device according to claim 6,
wherein the network control unit and the host control unit mount a first driver for communication with an external device which is connected to the network and a second driver for communication with the encryption/decryption application as the network device drivers respectively, and
wherein the host control unit selects between the communication with the external device and the communication with the encryption/decryption application by designating network IP addresses assigned to the first driver and the second driver mounted on the network control unit.
